(19) United States
(12) Patent Application Publication
(10) Pub. No.: US 2014/0169790 A1
(43) Pub. Date: Jun. 19, 2014

(54) MAGNETO-OPTICAL LOGIC DEVICES AND COMPUTATION

(71) Applicants: Maurice MCGLASHAN-POWELL, Kingston (JM); University of Technology, Jamaica, Kingston (JM)

(72) Inventor: Maurice MCGLASHAN-POWELL, Kingston (JM)

(21) Appl. No.: 13/933,669

(22) Filed: Jul. 2, 2013

(30) Foreign Application Priority Data
Dec. 19, 2012 (JM) 18/1/5366

(51) Int. Cl. H04Q 11/00

(52) U.S. Cl. CPC H04Q 11/0003
USPC 398/45

(57) ABSTRACT

Disclosed is a method and apparatus for optical computing using magneto-optical elements as logic devices. Essential logic and computing elements have been implemented.

### REFERENCES CITED

### Magneto-Optical Interconnect Refs:

U.S. Pat. No. 6,816,637: Magneto-optical switching backplane for processor interconnection
U.S. Pat. No. 7,298,935 Waveguide polarization beam splitters and method of fabricating a waveguide wire-grid polarization beam splitter
Ultrafast magneto-optic sampling of picosecond current pulses
Appl. Phys. Lett. 68, 3546 (1996)
A Miniature Broadband Bismuth-substituted Yttrium Iron Garnet Magneto-optic Modulator
J. Phys. D: Appl. Phys. 36 (2003) 2218-2221
A Gigahertz Surface Magneto-Plasmon Optical Modulator
IEEE Journal of Quantum Electronics, Vol., 40, No. 5, May 2004

### CROSS-REFERENCE TO RELATED APPLICATIONS

The present application claims priority from Jamaican Patent Application No. 18/1/5366, filed Dec. 19, 2012, the contents of which are herein incorporated by reference in its entirety.

### FIELD OF THE INVENTION

A method of using the magneto-optic effect in Bi-YIG or other magneto-optic waveguides along with sub-wavelength grating polarization beam splitter to develop optical logic devices capable of switching at multi-gigahertz and possibly terahertz frequencies has been invented.

### BACKGROUND

The need for optical computing and logic devices based on optics is becoming increasingly important as CMOS and VLSI technology approaches its limit. Attempts at developing optical logic devices and computing systems has been hindered by the use of electro-optic devices which require relatively large voltages, the nonlinear optical effect which require high powered pump lasers, and interferometric devices which are inherently slow.

The magneto-optic effect in Bi-YIG or other magneto-optic waveguides has been shown to be capable of switching optical signals at multi-gigahertz and possibly terahertz frequencies (Ref. Elezzabi and Freeman).

Magneto-optical logic devices based these magneto-optic waveguides in conjunction with sub-wavelength grating polarizers have been invented.

Various logic gates (NAND, AND, NOR, OR and XOR) are demonstrated Half Adder and Full Adder magneto-optics circuits are also demonstrated.

Ultrafast Magneto-optic switching based on Faraday rotation has been demonstrated up to the Giga Hertz range in Bi-YIG thin film waveguides (Ref. Elezzabi and M. Freeman). Using this effect and waveguides made from YIG or other magneto-optical material along with sub-wavelength polarizers built into passive waveguide (ex. SiON) (Ref. U.S. Pat. No. 7,298,935) several logical devices can be implemented. These varied devices are herein described.

### The Magneto-Optic and Faraday Effect

The magneto-optic effects arises from the loss of cubic symmetry of the dielectric tensor when a magnetic field is applied along the Z-direction

$${ɛ}_{ij} = [ \begin{matrix}{ɛ}_{11} & {iɛ}_{12} & 0 \\ - {iɛ}_{12} & {ɛ}_{11} & 0 \\ 0 & 0 & {ɛ}_{33}\end{matrix} ]$$

The observed Magneto-optic rotation/unit length resulting from the phase difference between the right and left circularly polarized states or normal mode of propagation is as follows:

$${Φ}_{F} = \frac{π}{λ} Re ( {N}_{+} - {N}_{-} )$$

Where N₊=\sqrt{∈₁₁+∈₁₂} and N₋=\sqrt{∈₁₁−∈₁₂}

The Faraday Effect or Magneto-Optic Rotation (MOR) relates to the direction of magnetization as follows:

Φ_{F}=V\vec{k}·\vec{M}=VkM cos θₖₘ

### Where

V→Verdet Coefficient
M→Magnetization
k→Propagation vector
θₖₘθAngle between k and M (See FIG. 6 for a generic drawing of the Faraday Effect)

### Magneto-Optics Waveguides

Magneto-optics waveguides are fabricated from materials that exhibit the Faraday Effect or Magneto-optic rotation (MOR). Modified YIG thin films exhibit Large Faraday rotation, low switching fields (1-2 Oe) the small switching currents. These materials are bistable by virtue of their magneto-crystalline anisotropy thus requiring only a momentary current pulse to reorient the magnetization. The materials can be modified to yield large MOR, fast magnetization dynamics. Switching speeds up to 83 GHz have been demonstrated (ref. Irvine et al, J. Phys. D, 36 (2003)). Optical losses are low and are on the order of −0.9 dB in the 1 to 2 microns range. Magneto-optic waveguides can be fabricated using Bismuth modified YIG waveguides, with index of refraction of 2.18, deposited by LPE on gadolinium gallium garnet (GGG) substrate with index of refraction of 1.94. The cover layer of this waveguide could be air or GGG. Issues of birefringence which limit the effective Faraday rotation can be eliminated by engineering the magneto-optic thin film with the proper lattice mismatch between the Bi-YIG and the GGG substrate (Ref. MMP et Al Phys rev). This lattice mismatch will introduce a stress birefringence that counters the geometric birefringence introduced when the YIG film thickness is comparable to the wavelength of the laser radiation.

### SUMMARY

This invention utilizes the Faraday Effect, magneto-optical and passive waveguides, polarizers, VCSEL and photo detectors to implement various magneto-optical logic and computing devices. Electrical signals are used to modulate the magnetization of the magneto-optical waveguide. All necessary logic and computing elements for building a magneto-optical computer system is illustrated. The logic devices are capable of switching at Gigahertz frequencies and the possibility of Terahertz operation is presented.

### BRIEF DESCRIPTION OF THE DRAWINGS

FIG. 1 Magneto-optical AND gate implementation with truth table.

FIG. 2 Magneto-optical NOR gate implementation with truth table

FIG. 3 Magneto-optical XOR gate implementation with truth table

FIG. 4 Magneto-optical half adder

FIG. 5 Magneto optical Full Adder.

FIG. 6 The Faraday Effect

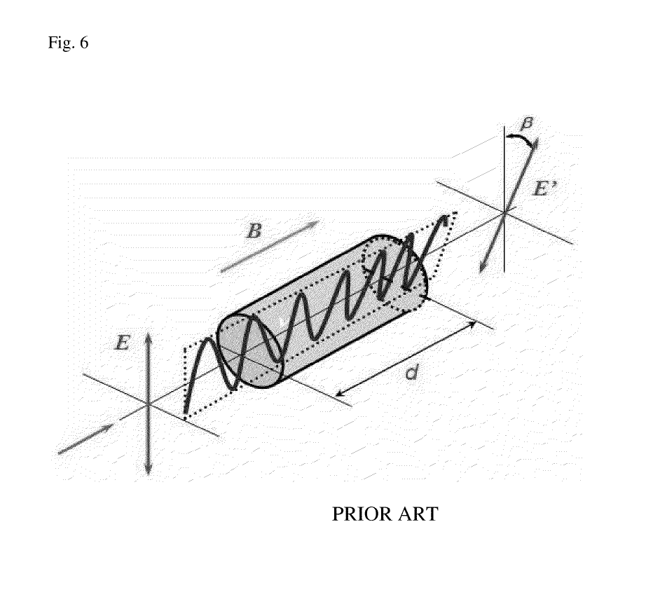

### DETAILED DESCRIPTION

Magneto-optic Logic gate are implemented by utilizing the following:
Magneto-optics waveguides
Sub-wavelength polarizers (ref U.S. Pat. No. 7,298,935)
Passive waveguides (ex. SiON)
High frequency (RF) strip line circuit for switching magnetization
Laser sources (VCSELs) for launching optical signals into the waveguides
Photo detectors

### Magneto-Optic AND Gate Implementation

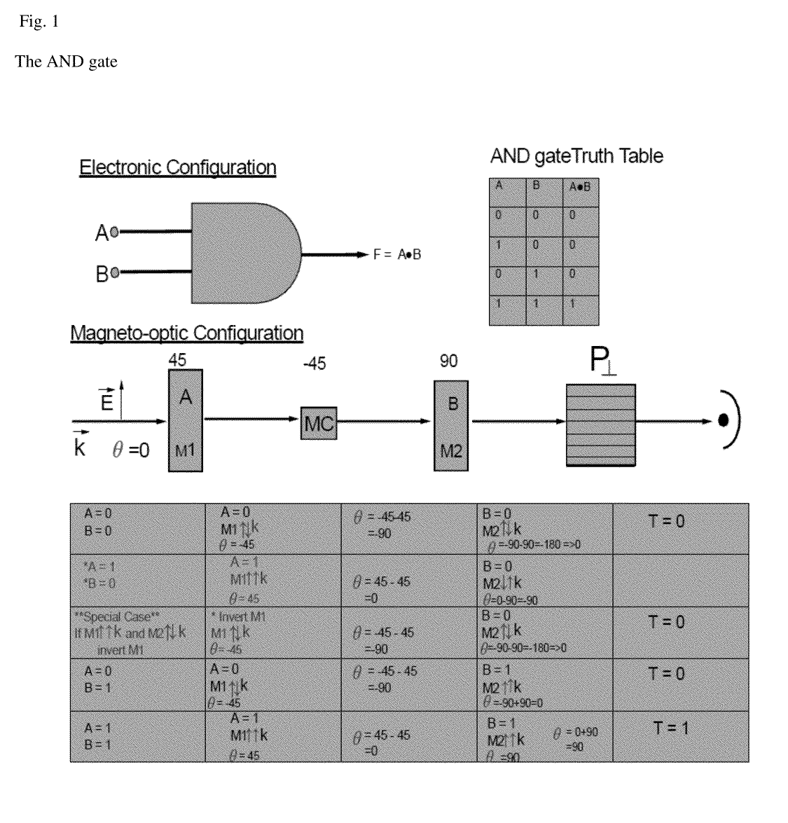

An AND gate can be fabricated using magneto-optic waveguides and polarizer as depicted in FIG. 1. Magneto-optic waveguide elements MO1 and MO2 impart ±45° and ±90° Faraday rotation respectively and MC gives a constant −90° rotation. The magnetization of MO1 and MO2 can be switched by applying a current ±Iₘ₁ and ±Iₘ₂. The input optical signal is launched into a passive waveguide structure with the electric field vector (E) within the plane of the waveguide (TE mode). The evolution of the polarization state is shown in the table in FIG. 1 and is delineated as follows:
1) The input signal enters the first magneto-optics element MO1.
   The magnetization of this element can be switched from parallel (M↑↑k) to anti-parallel (M↑↓k) relative to the k vector by applying a magnetic field which is generated from a strip line conductor carrying current Iₘ.
2) If the magnetization M1 is parallel to the k vector (direction of propagation) the optical signal rotates 45 degrees.
3) If M1 is anti-parallel to the k vector the plane of polarization rotates −45 degrees. These two states (M↑↑k and M↑↓k), corresponds to the two possible input states of the AND gate of zero and one (0,1), or
   M↑↑k, corresponding to a logical state of 1 (A=1) and M↑↓k corresponding to the logical state of zero (A=0).
4) The optical signal then impinges upon magneto-optical waveguide element MC which adds a constant −45 degrees rotation to the incoming polarization of either 45 or −45 thus yielding an output polarization of either zero (θ_{F}=0=−45+45) or 90 degrees (90=45+45).
5) The final magneto-optical element (MO2) then imparts either 90° or −90° of rotation depending on the magnetization M2 of the magneto-optic element MO2. The direction of the magnetization is again determined by the magnetic field B which is generated by a current carrying conductor in close proximity to the magneto-optic element
6) The output state of this final magneto-optic element (MO2) is either zero or one (0, 1) depending on the orientation of the magnetization relative to the k vector and the output state of magneto-optic element MO1.
   If M1↑↑k and M2↑↑k the final output polarization sate is 90 degrees
   If M1↑↓k and M2↑↑k the output state is θ_{F}=0°=−45°±45°
   If M1↑↓k and M2↑↓k the output state is −180°=>0°
7) For the case where M1↑↑k and M2↑↓k, the output state becomes −90°. In order to satisfy the truth table for the AND gate, it is necessary to have the Faraday rotation (θ_{F}) for the condition (M1↑↑k and M2↑↓k) have a value of zero. This is achieved by inverting the current to the MO1 magneto-optic element. A simple circuit inverts the current going to MO1 if (Iₘ₁>0 and Iₘ₂<0).
8) The output of the final magneto-optic element (MO2 impinges upon a polarizer (P⊥) which is perpendicular to the input state of the MO1 element. The optical signal which is incident upon this polarizer is transmitted if the output of the MO2 magneto-optic element is in the TM mode (θ_{F}=90° or vertically polarized relative to the waveguide) and extinguished if the output of MO2 is in the TE mode (E vector in the plane of the waveguide). Transmission through this polarizer corresponds to the logical state of one (1) or TRUE and extinction (zero transmission) corresponds to a logical state of zero (0) or FALSE. The truth table for the AND gate is seen in FIG. 1 and the corresponding input sate of the AND gate (A and B) are shown to be equivalent to the magnetization state (M1 and M2) of the magneto-optic elements M01 and MO2 where:
A=1 Corresponds to the case where the magnetization of MO1 is parallel to the direction of propagation (M1↑↑k).
A=0 Corresponds to (M1↑↓k) or the case where the magnetization (M) of magneto-optic element MO1 is anti-parallel to the direction of the propagation (k).
and
B=1 Corresponds to the case where the magnetization of the magneto-optic element MO2 is anti-parallel to the k vector (M2↑↑k).
B=0 Corresponds to the case where the magnetization of the magneto-optic element MO2 is anti-parallel to the direction of propagation (k) (M2↑↓k).

The transmission of the system (T) is shown to correspond to the truth table of the AND gate (FIG. 1). The NAND gate is created by changing the output polarizer from perpendicular to the TE mode (P⊥) to parallel (P∥).

### The Magneto-Optic NOR Gate Implementation

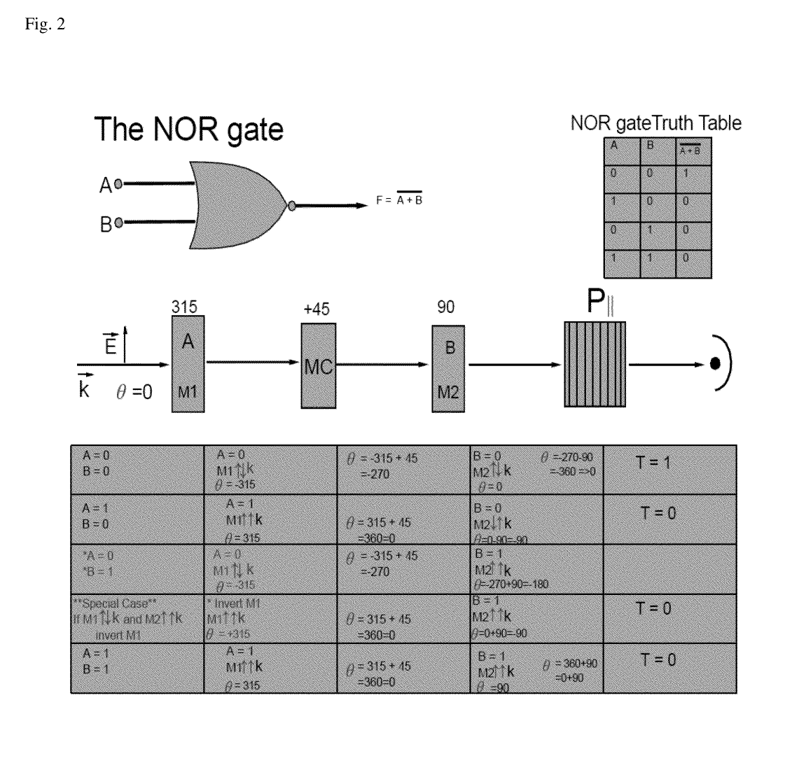

The NOR gate can be implemented using magneto-optics waveguides and polarizer as depicted in FIG. 2. The MO1 magneto-optic waveguide element imparts ±315° Faraday rotation and MO2 element imparts ±90°. The magnetization M1 and M2 can be switched by applying a currents ±Iₘ₁ and ±Iₘ₂. Here magneto-optic element MC imparts a constant +90° Faraday rotation and the output polarizer is parallel to the input polarization state (TE mode). The evolution of the polarization state is shown in the table in FIG. 2 and it progresses similar to what has been described previously for the AND gate. The transmission of the system is shown to correspond to the truth table of the NOR gate (FIG. 2). Similar to the case of the AND gate and NAND, the OR gate is created by changing the output polarizer from parallel to the TE mode (P∥) to perpendicular (P⊥).

### The Magneto-Optic XOR Gate Implementation

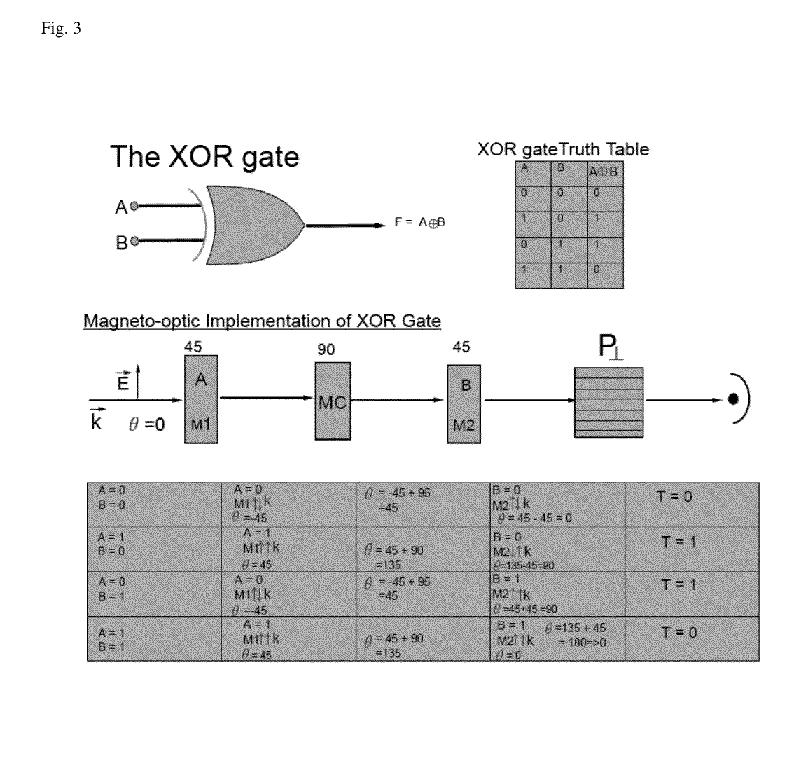

The XOR gate is similarly implemented using magneto-optics waveguides and polarizer as depicted in FIG. 3. Here the MO1 and MO2 magneto-optic waveguide elements impart ±45° Faraday rotation. The magneto-optic element MC imparts a constant +90° Faraday rotation and the output polarizer is perpendicular to the input polarization state (TE mode). The evolution of the polarization state is shown in the table in FIG. 3. The transmission of the system is shown to correspond to the truth table of the NOR gate (FIG. 3).

### The Half Adder

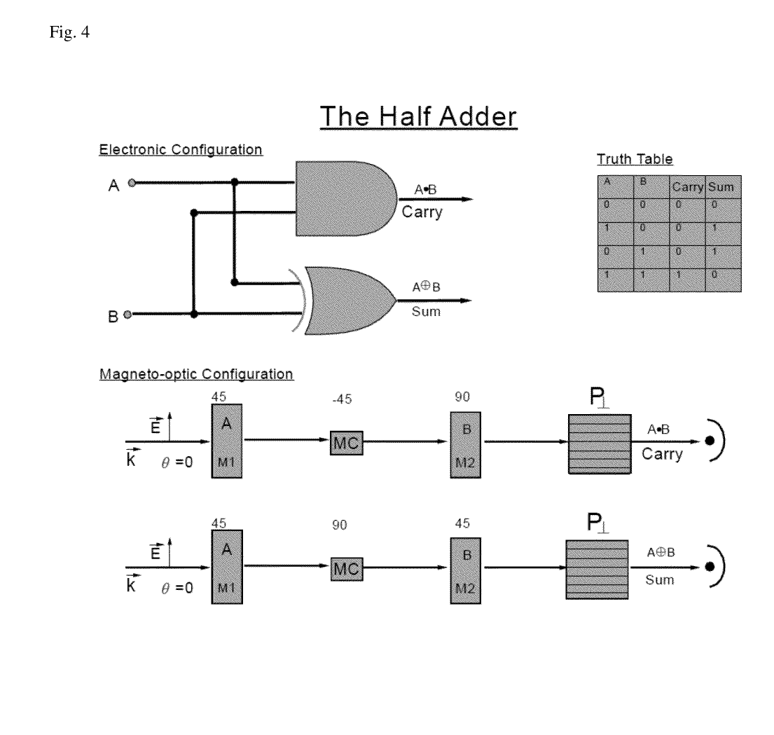

The electronic configuration of the half adder is comprised of an AND gate and an XOR gate as depicted in FIG. 4. The magneto-optic configuration and corresponding truth table is shown in FIG. 4.

### The Full Adder

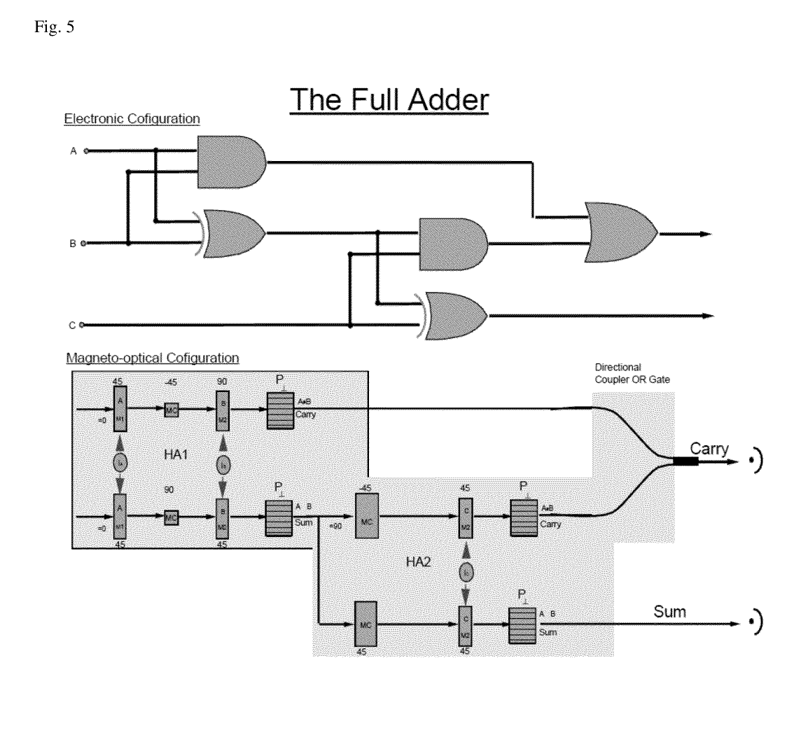

The Full Adder is comprised of two half adders and an OR gate as depicted in the Electronic configuration of FIG. 5. The magneto-optic implementation is shown in FIG. 5 but with the second half adder (HA2) modified as shown.

The waveguide carrying the XOR output or SUM of the first MO Half adder (HA1) is directed to both the “CARRY” and “SUM” input of the second half adder (HA2) by virtue of beam splitter or directional coupler. The input to the “CARRY” and “SUM” of the second half adder is replaced by a magneto-optic element MC with a constant −45° for the Carry input and +45° for the Sum input (FIG. 5). The second half adder (HA2) in the MO implementation is comprises of only one MO switching element (M3) which is either ±45° depending on the polarity of the drive current Iₘ₃. The OR gate in this configuration can be implemented by merging the output of the “carry” of both half adders using a modified directional coupler whose output is coupled into the photo detector as shown (FIG. 5).

The transmission of the system can be shown to correspond to the truth table for the Full Adder (FIG. 5).

1. A method of digitally switching a signal, the method comprising:
receiving electromagnetic radiation as an input signal:
selectively rotating a plane of rotation of said electromagnetic radiation using a plurality of Magneto-optic rotating elements;
selectively transmitting a predetermined polarization of electromagnetic radiation to a detector using a polarizer; and
reading a value of said detector as an output signal.

2. A magneto-optic logic gate comprising:
a plurality of magneto-optics waveguides to rotate a polarization of light;
a plurality of passive waveguides to direct the light;
a plurality of polarizers incorporated into said passive waveguides;
a high frequency strip line circuit or other method of switching magnetization;
a laser source to launch a least one optical signal into at least one of said magneto-optic waveguides and said passive waveguides; and
a photo detector.

3. (canceled)

4. The method of claim 1, wherein implementing said logic devices uses magneto-optical rotation or the Faraday effect

5. The method of claim 4, further comprising:
using a magneto-optics waveguides polarization beam splitter (PBS) or polarization selective devices (P), a magneto-optic rotator (MOR) and sub-wavelength wire grid polarizer or a polarization selective element.

6. (canceled)

7. (canceled)

8. The computer or computing device or computing element according to claim 9, further comprising:
a polarization selective element; and
wherein rotation or manipulation of the plane of polarization or polarization state of light is performed.

9. A computer, computing device or computing element comprising:
a magneto-optic Rotator (MOR) for controllably rotating the polarization angle of said polarized light: and
a polarizer (P) that transmits or rejects polarized light from said MOR;
wherein transmitted light then impinges on a photo detector thus indicating a logical state of one “1”; and
wherein rejected light results in a zero logical state.

10. The computer, computing device or computing element of claim 9,
wherein said MOR comprises:
a first section,
wherein in said first section a magnetic field is selectively switched between two modes, and wherein in said two modes said magnetic field has equal magnitude and opposite directions, whereby in said first section said polarization angle is rotated by a fixed magnitude and selectively in opposite directions; and
a second section following the first section,
wherein in said second section a permanent magnetization prevails, whereby in said second section said polarization angle is rotated by a constant value; and
a third section following the second section,
wherein in the third section a magnetic field is selectively switched between two modes and wherein in said two modes said magnetic field has equal magnitude and opposite directions.

11. The computer, computing device or computing element according to claim 10,
wherein said computing element is at least one of an AND, NAND, OR, XOR, or NOR gate, and
wherein in said first section of a fixed magnitude of said polarization angle rotation is approximately 45°, for the AND gate, the NAND gate, and the XOR gate, and 315° for the OR gate and NOR gate,
whereby said polarization angle in said first section is selectively rotated approximately by +45° or −45° for the AND gate, the NAND gate, and the XOR gate, and +315° or −315° for the OR gate and NOR gate, and in said second section said constant value of said polarization angle rotation is approximately 45° for the NOR and OR gates, −45 for the AND and NAND gate, and 90 for the XOR gate, and in said third section of a fixed magnitude of said polarization angle rotation is approximately 90°, for the AND gate, the NAND gate, the OR and NOR gate, and 45° for the XOR gate,
whereby said polarization angle of said third section is selectively rotated by approximately by +90° or −90° for the AND, NAND, NOR and OR gates, and +45 or −45 for the XOR gate,
whereby said polarization angle, upon said polarized light passing through said first section and said second section and said third section is selectively rotated 90° or 0°.

12. The computer, computing device or computing element according to claim 11, wherein said MOR are waveguides, wherein each of said waveguides comprising a magneto-optical active layer guiding said polarized light.

13. The computer, computing device or computing element according to claim 12, wherein said first and said second section waveguides further comprise at least one additional optical layer, said additional layer interfacing with said magneto-optically active layer, wherein said additional layer includes a lower refractive index than said magnet optically active layer.

14. The computer, computing device or computing element according to claim 13, wherein said magnetic field in said first section of said MOR is generated by a current flowing in a metallic strip, wherein said metallic strip substantially covers said first section.

15. The computer, computing device or computing element according to claim 14, wherein said magneto-optically active layer comprises Yttrium Iron Garnet (YIG), and one of said additional optical layers comprises Gadolinium Gallium Garnet (GGG).

16. (canceled)

17. The computer, computing device or computing element according to claim 9, wherein said computer, computing device or computing element is part of an optical waveguide network.

18. The computer, computing device or computing element according to claim 17, wherein said polarizer (P) or a polarization beam splitter (PBS) is an optical element constructed into said optical waveguide network.

19. The computer, computing device or computing element according to claim 17, wherein said polarizer (P) or a polarization bean splitter (PBS) is a vertical polarization grating etched into said waveguide network.

20. The computer, computing device or computing element according to claim 17, wherein said P or PBS is a Brewster angle beam splitter etched into said waveguide network.

21. The computer, computing device or computing element according to claim 17, wherein said P or PBS is a birefringent prism built into said waveguide network.
